(19) United States
(12) Patent Application Publication
(10) Pub. No.: US 2025/0272702 A1
(43) Pub. Date: Aug. 28, 2025

(54) METHODS AND SYSTEMS FOR REAL ESTATE DATA MODELING

(71) Applicant: Indaago, LLC, Atlanta, GA (US)

(72) Inventor: Margaret Tawes Herlihy, Atlanta, GA (US)

(21) Appl. No.: 19/061,654

(22) Filed: Feb. 24, 2025

Related U.S. Application Data
(60) Provisional application No. 63/556,983, filed on Feb. 23, 2024.

(51) Int. Cl. G06Q 30/0202; G06Q 50/16

(52) U.S. Cl. CPC G06Q 30/0202; G06Q 50/16

(57) ABSTRACT

A computing device may be configured to receive real estate data and associate real estate metrics with design data, creating a unique real estate data intelligence platform. The computing device may be configured to analyze, summarize, and disseminate interior design data, exterior design data, decorative data, architectural data, and other data about one or more real estate listings, determine trends, and output recommendations to suppliers, builders, and consumers.

### CROSS-REFERENCE TO RELATED APPLICATION

This application claims the priority benefit of U.S. Provisional Application No. 63/556,983, filed Feb. 23, 2024, the entirety of which is incorporated herein by reference.

### BACKGROUND

At present, the homebuilding decision-making process involves a team of professionals, including market analysts, researchers, architects, artists, project managers, and compliance specialists. Employing such varied and experienced professionals may prove prohibitively expensive and by virtue of the number of people involved, is very susceptible to human error. Thus, improved material supply analytics and home building systems are needed.

### SUMMARY

It is to be understood that both the following general description and the following detailed description are explanatory only and are not restrictive.

Multiple Listing Services (MLS) databases serve as comprehensive repositories of information for real estate listings. Within these databases, various data fields capture essential details about properties, including address, legal description, property type (e.g., residential, commercial, land), size, and dimensions. Listings include pricing information, listing dates, and status indicators such as whether a property is active, pending, or sold. Detailed features like the number of bedrooms and bathrooms, square footage, lot size, and year built are recorded, along with information on amenities, special features (e.g., pool, fireplace), and included appliances. Property condition details, such as the age and condition of major systems, provide insights for potential buyers.

Provided herein are one or more methods or systems for a system configured to optimize supplier purchasing decisions and home construction recommendations. For example, AI and machine learning may be used to identify the features in the property images quickly, accurately, and efficiently—for instance, identifying a black single lever faucet within an image. The data may then be provided to end users, like home builders for instance, to make their own conclusions as to how to optimize their properties. The present methods and systems are configured to optimize understanding of buyer behavior or purchase patterns in the residential real estate market. For example, the present methods and systems may gather data based on Multiple Listing Service (MLS) data. This system may gather pertinent information from MLS databases, including property features, historical sales data, and market trends. Employing advanced machine learning models, the system may data to identify patterns, trends, and preferences related to various property features.

The present methods and systems may use some existing MLS data and may also be configured to create new data that is captured by annotating (e.g., programmatically annotating) the images and text data from listed or sold properties. The present methods and systems may pair this with the MLS data to get a better understanding of the property—particularly as it pertains to design and architectural features, which are major factors for most buyers. The system may determine optimal purchases for home suppliers and may also determine optimal home configurations for builders to maximize square foot prices, considering factors such as market demand, regional conditions, and historical data. Recommendations, tailored to meet builder preferences and market demands, may be generated and presented to homebuilders through an intuitive user interface. This innovative approach may leverage AI to enhance decision-making in the construction industry, aiming to increase efficiency and profitability for homebuilders.

Provided herein are one or more systems or methods for supply decisioning. The system may make use of MLS data and metadata created by an AI data tagging system. The AI data tagging system may be configured to analyze text and image data and create supplemental data. The system may be configured to extract valuable insights for home improvement and home supply companies. Through advanced data analytics and machine learning algorithms, this system may determine historical sales data, demographic information, and regional economic indicators to identify emerging trends and consumer preferences in different geographic areas. By analyzing patterns such as renovation frequency, popular home improvement projects, and material preferences across regions, the system may generate and output actionable recommendations for stocking materials. The system may be configured to take actions such as making purchasing orders and/or causing the construction of a premises. For instance, in regions experiencing a surge in kitchen renovations, the system might suggest increasing stock of granite countertops and stainless steel appliances. Conversely, in areas where outdoor living spaces are in high demand, recommendations may lean towards decking materials and outdoor furniture. These recommendations may be tailored to each region's unique characteristics, ensuring that home improvement and supply companies can optimize their inventory to meet local market demands effectively. Continuous monitoring and updating of data may ensure that recommendations remain relevant and responsive to evolving consumer preferences and market dynamics, empowering companies to make informed decisions and stay ahead in a competitive landscape.

Provided herein are one or more systems for comprehensively managing a real estate transaction which includes a real estate multiple-listing system, a system for managing real estate purchases, a system for managing real estate closings, a system for managing post-closing activities, and a method for accessing said real estate multiple-listing-system, said system for managing real estate purchases, said system for managing real estate closings, and said system for managing post-closing activities, through a network. The system may be configured to carry out a method for granting access to a participant or a potential participant in a real estate transaction and include a method for accessing real estate-related vendor information. The system may be configured to carry out a method for inputting information such as, for example, contact information of a participant or a potential participant in a real estate transaction. The system may also be configured to carry out a method for uploading information related to the transaction such as, for example, real estate-related information. The system may be configured to carry out a method for electronically delivering real estate-related information to a participant or a potential participant in a real estate transaction such as, for example, email. The real estate-related information may be, for example, referrals, vendor contacts, real estate listings, county property tax records, representation agreements, offers, offer agreements, inspection reports, lending documents, closing documents and related documents.

Provided herein are one or more methods or systems for accessing a wide variety of real estate-related documents through a network. The system may be configured to carry out a method for restricting access to real estate-related documents to certain transaction participants or potential participants. The system may be configured to carry out a method for updating and modifying real estate-related documents through a network. The real estate-related documents may be, for example, listing agreements, agent representation agreements, offers, offer agreements, lending documents, closing documents or similar documents. The system may be configured to carry out a method for electronically signing documents. The system may be configured to carry out a method for automatically notifying a participant or a potential participant when real estate-related documents are modified. The system may be configured to carry out a method for tracking, monitoring and logging the development of a real estate transaction. The system may be configured to carry out a method for updating the status of the development of a real estate transaction. The system may be configured to carry out a method for granting a participant or a potential participant in a real estate transaction access to a transaction activity log or other summary or list showing the status of the transaction. The system may be configured to carry out a method for automatically notifying a participant or a potential participant in a real estate transaction when the status of the development of said real estate transaction is updated. The system be configured to carry out a method for ordering real estate-related services through a network. The system may be configured to carry out a method for agents to generate new marketing leads. The system may be configured to carry out a method for creating a private webpage for a buyer or a seller. The system may be configured to carry out a method for posting information to a buyer or seller's private webpage. The system may be configured to carry out a method for automatically notifying a buyer, a seller, or an agent when information is posted to a buyer or a seller's private webpage. The system may also be configured to carry out method for a seller and an agent to interact through electronic communication while viewing information posted on said seller's private webpage. The system may be configured to carry out a method for a buyer and an agent to interact through electronic communication while viewing information posted on said buyer's private webpage. The system may be configured to carry out a method for an agent to conduct a comparable market analysis over a network. The system may also be configured to carry out method for a buyer to contact lenders. The system may be configured to carry out a method for buyer to apply for loans on-line. The system may also be configured to carry out method for searching third party databases, such as MLS and county records for data related to the real property, such as property address and county tax data. The system may be configured to carry out a method for an agent to define and save search criteria from a buyer's contact information. The system may be configured to carry out a method for an agent to identify properties that match a buyer's criteria. The system may be configured to carry out a method for routine automated searches for property that match a buyer's criteria. The system may be configured to carry out a method for a buyer, a seller and their respective agents to access real estate-related documents through a network. The system may be configured to carry out a method for a buyer, a seller and their respective agents to interact through electronic communication while accessing real estate-related documents through a network. The system may be configured to carry out a method for automatically notifying a buyer, a seller, and their respective agents of electronic communication by said buyer, said seller or said agents. The system may be configured to carry out a method for acquiring electronic copies of title closing documents from a title provider through a network. The system may be configured to carry out a method for acquiring electronic copies of lender closing documents from a lender through a network. The system may be configured to carry out a method for providing information related to closed transactions to secondary mortgage lenders through a network.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, and together with the description, serve to explain the principles of the methods and systems:

FIG. 1 shows an example system;

FIGS. 2A-2B show example databases;

FIGS. 3A-3F show example data;

FIG. 4 shows an example method;

FIG. 5 shows an example method;

FIG. 6 shows an example method;

FIG. 7 shows an example method;

FIG. 8 shows an example method; and

FIG. 9 shows an example system.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular features only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another range includes from the one particular value and/or to the other particular value. Similarly, when values are expressed as approximations, by use of the antecedent “about,” it will be understood that the particular value forms another value. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Such as” is not used in a restrictive sense, but for explanatory purposes.

Components that may be used to perform the present methods and systems are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all sections of this application including, but not limited to, steps in described methods. Thus, if there are a variety of additional steps that may be performed it is understood that each of these additional steps may be performed with any specific step or combination of steps of the described methods.

As will be appreciated by one skilled in the art, the methods and systems may be implemented using entirely hardware, entirely software, or a combination of software and hardware. Furthermore, the methods and systems may take the form of a computer program product on a computer-readable storage medium having computer-readable program instructions (e.g., computer software) encoded on the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described below with reference to block diagrams and flowchart illustrations of methods, systems, apparatuses and computer program products. It will be understood that each block of the block diagrams and flowcharts, and combinations of blocks in the block diagrams and flowcharts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

Note that in various cases described herein reference may be made to a given entity performing some action. It should be understood that this language may in some cases mean that a system (e.g., a computer) owned and/or controlled by the given entity is actually performing the action.

The present disclosure is relevant to systems and methods for determining square foot prices of one or more properties and/or recommendations for builders related thereto.

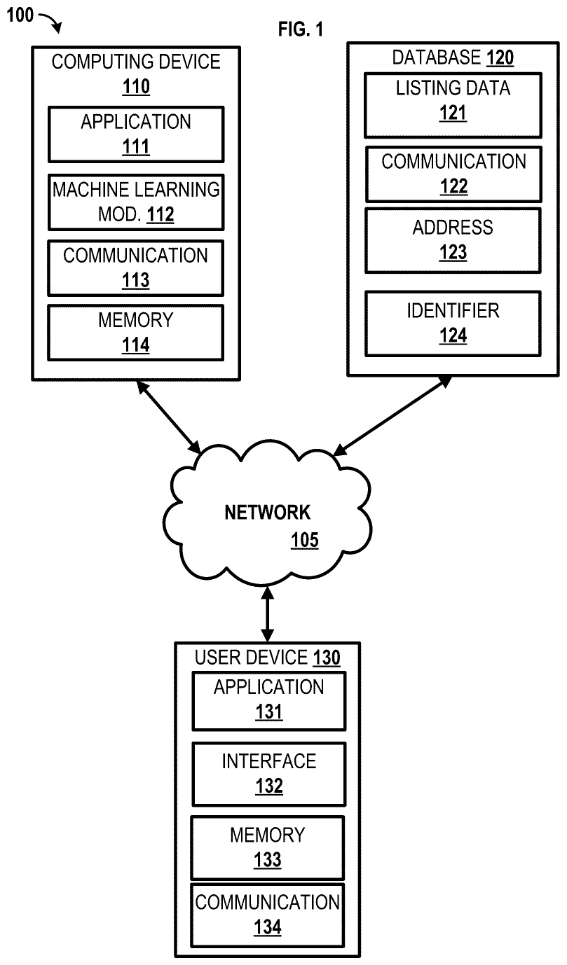

FIG. 1 shows an example system 100 configured to facilitate the methods described herein. The system 100 may comprise a computing device 110, a database 120, and a user device 130. The computing device 110 may be disposed locally or remotely relative to the database 120 and/or the user device 130. The computing device 110, the database 120, and the user device 130 may be in communication via a private and/or public network 105 such as the Internet or a local area network. Other forms of communications may be used such as wired and wireless telecommunication channels. A network device may be in communication with a network such as network 105. One or more of the network devices may facilitate the connection of a device, such the computing device 110, the database 120 and/or the user device 130, to the network 105. The network device may be configured as a wireless access point (WAP). The network device may be configured to allow one or more wireless devices to connect to a wired and/or wireless network using Wi-Fi, BLUETOOTH®, or any desired method or standard.

The network device may be configured as a local area network (LAN) or wide area network (WAN). The network device may be a dual band wireless access point. The network device may be configured with a first service set identifier (SSID) (e.g., associated with a user network or private network) to function as a local network for a particular user or users. The network device may be configured with a second service set identifier (SSID) (e.g., associated with a public/community network or a hidden network) to function as a secondary network or redundant network for connected communication devices.

The network device may have an identifier. The identifier may be or relate to an Internet Protocol (IP) Address IPV4/IPV6 or a media access control address (MAC address) or the like. The identifier may be a unique identifier for facilitating communications on the physical network segment. There may be one or more network devices. Each of the network devices may have a distinct identifier. An identifier may be associated with a physical location of the network device.

The system 100 may be configured to determine one or more features of interest. The system 100 may be configured to automatically determine the one or more based on one or more of text data or image data received from the database 120.

The system 100 may identify/detect/determine dimension data, design data, and architecture data based on the text data and image data received from the database. The system 100 may determine features within its field of view and images of the features may be tagged with feature-labels that identify the features. Images of the one or more properties may be tagged with labels such as, “window,” “door,” “stairs,” “range,” and the like. The system 100 may be configured to determine the features within the image data.

A feature segmentation map may be generated, based on the identified/detected features. One or more feature segmentation maps and associated information may be used to train the system 100 and/or any other system (e.g., a camera-based neural network, etc.) to automatically identify/detect features of interest (FOIs) and/or objects of interest within a field of view.

Key functionalities of the application 111 may include data manipulation, communication facilitation, automation of tasks, connectivity to the internet or other devices, and customization of settings. Moreover, the application 111 may leverage platform-specific features to optimize performance and user experience. For example, the application 111 may be configured for sending queries and receiving data associated with a Multiple Listing Service (MLS). The data may comprise dimension data, design data, and architecture data. The dimension data may comprise one or more of: lot size, building size, room dimensions, property boundaries, floor plans, frontage, depth, height, setback, orientation, easements, landscaping features, garage or parking dimensions, additional structures, utility lines, and cubic footage.

For example, the design data may include information about interior design such as details about the arrangement and dimensions of rooms within the property, information regarding the materials used for flooring in different areas, descriptions of wall materials, finishes, and colors throughout the interior, details about the design, height, and materials of the ceilings, specifications for light fixtures, including types and locations, information about curtains, blinds, or other window coverings, descriptions of built-in furniture, shelves, or storage units, details about the design, materials, and placement of fireplaces, information about kitchen and laundry appliances, details regarding the design, materials, and finishes of cabinets in kitchens and bathrooms, information about the materials and dimensions of kitchen and bathroom countertops, specifications for interior doors, including style and materials, descriptions of the color schemes used throughout the property, information about the arrangement of furniture in various rooms, details about any unique or special interior design features, information regarding home automation systems and smart home features, descriptions of artwork and decorative elements within the property, information about the types and materials of textiles used, such as curtains, rugs, and upholstery, details about the design and materials of sinks, faucets, and other bathroom fixtures, and information regarding the presence and type of storage solutions, including closets and built-in storage.

For example, architectural data may include architectural style date (e.g., information about the design style of the building, such as Colonial, Victorian, Modern, or Mediterranean), materials used (e.g., details on the construction materials employed, such as brick, wood, concrete, or steel), roof type (e.g., description of the style and material of the roof, whether it's gabled, flat, pitched, or uses architectural shingles), facade details (e.g., ornamental features on the exterior, including shutters, millwork, decorative trim, columns, or architectural embellishments), windows and doors design (e.g., information about the style, size, and material of windows and doors, including any unique architectural features), architectural elements (e.g., features like arches, dormers, balconies, or porticos that contribute to the building's overall design), interior layout (e.g., configuration and design of interior spaces, including the arrangement of rooms, hallways, and common areas), historical significance (e.g., any historical or cultural significance associated with the architectural design or the building itself), specialized features (e.g., skylights, fireplaces, built-in shelving, or unique staircases), landscaping design (e.g., architectural aspects related to the outdoor space, including gardens, patios, pathways, and other landscaping features), one or more kitchen elements (e.g., cabinetry type and finish, plumbing systems and finishes, tile details, lighting design and elements, countertops, appliance details) combinations thereof, and the like.

The computing device may comprise a machine learning model 112. The machine learning model 112 may be configured to efficiently leverage a comprehensive dataset obtained from the Multiple Listing Service (MLS) or other data source. This dataset includes a rich array of information, including textual data, such as detailed property descriptions and features, as well as image data, including photographs and floor plans. To prepare the data for analysis, the model may be configured to implement preprocessing steps. For textual information, this may involve cleaning the data to remove noise and irrelevant details, and then transforming it into a format suitable for machine learning algorithms. The system may be configured to eliminate unnecessary images and rectify blurry and repeat images). Techniques like tokenization and stemming may be employed to extract meaningful features from the text. Similarly, the image data may be subjected to normalization procedures, such as resizing and feature extraction, to ensure that visual information is effectively represented. The machine learning model 112 may be configured to integrate these two types of data seamlessly. This integration process may include strategies like concatenation of features or the utilization of sophisticated multimodal models, allowing the model to effectively capture the synergies between textual and image features.

The system may be configured for programmatic labeling. For example, an ML/AI system can be implemented to analyze both image and text data extracted from real estate listings. This system may employ advanced computer vision algorithms to process images of properties, identifying various features such as architectural styles, room types, and structural elements. Additionally, natural language processing (NLP) techniques may be utilized to parse textual descriptions accompanying the listings, extracting key information such as property descriptions, amenities, and renovation details. The ML/AI system is configured to programmatically label the data by categorizing images and text into relevant tags or labels. For example, it may automatically label images with tags like “kitchen renovation,” “outdoor living space,” or “modern interior design,” based on the visual content identified through image analysis. Similarly, textual descriptions can be labeled with tags such as “hardwood floors,” “granite countertops,” or “energy-efficient appliances” based on the extracted information.

Furthermore, as the ML/AI system continues to analyze data, it may learn from patterns and correlations within the dataset. This learning process allows the system to supplement the data by identifying additional relevant features or attributes that may not have been explicitly mentioned in the original listings. For instance, if the system consistently observes that properties with large windows tend to attract higher interest in certain regions, it may automatically supplement the data with a “large windows” label for similar properties in similar areas.

By continuously analyzing both image and text data and programmatically labeling it, the ML/AI system enhances the richness and granularity of the dataset, providing deeper insights into market trends and consumer preferences. These labeled datasets can then be utilized for various purposes such as training predictive models, generating personalized recommendations, and optimizing inventory management strategies for home improvement and supply companies.

For the core machine learning tasks, the machine learning model 112 may be configured to use regression techniques, such as linear regression, decision trees, or advanced deep learning approaches, depending on the complexity of the problem and the characteristics of the dataset. The ultimate objective may be to predict the price per square foot of potential homes based on the amalgamated features and/or maximize the square foot price by determining appropriate modification to existing homes.

To gauge the model's effectiveness, it may be configured to employ evaluation metrics like Mean Squared Error (MSE), Mean Average Precision (MAP) or Mean Absolute Error (MAE) on a dedicated validation dataset. This rigorous evaluation ensures that the model generalizes well to unseen data, a crucial aspect in real-world applications. Much more that we can write here.

Once trained and validated, the model may be configured to output one or more recommendations, take one or more actions such as placing purchasing orders, and or cause construction of a premises. For example, the system may be configured to recommend to home supply stores which materials they should stock based on market trends. For example, the system may be configured to recommend to manufacturers which materials to manufacture and at which price to sell to suppliers. This system may be configured to offer actionable insights to builders, suggesting specific modifications or enhancements that have the potential to increase the price per square foot of homes. These recommendations may include insights on desirable features, renovations, or design elements that the model has identified as positively influencing home prices.

This entire process may be iterative. The model may be configured to continuously learn and adapt based on new data and feedback, ensuring that it remains accurate and relevant in a dynamic real estate market. Regular updates and refinements based on ongoing insights contribute to the model's ability to provide valuable and up-to-date recommendations to builders seeking to optimize their pricing strategy.

The computing device may comprise a communications element 113. The communications element 113 may be configured to provide an interface to the database 120 and/or the user device 130. The communications element 113 may comprise any interface for presenting and/or receiving information to/from the user device and/or the database. An interface may be a communication interface such as a display screen, a touchscreen, an application interface, a web browser (e.g., Internet Explorer®, Mozilla Firefox®, Google Chrome®, Safari®, or the like). Other software, hardware, and/or interfaces may be used to provide communication between the computing device 110 and one or more of the database 120 and/or the user device 130. The communications element 113 may request or query various files from a local source and/or a remote source. The communications element 113 may send data to a local or remote device such as the computing device 110.

The computing device may comprise a memory 114 configured to store data. The memory 114 may comprise a diverse set of memory components configured for storing and managing different types of data, including dimension data, design data, and architecture data. The memory 114 may comprise cloud storage. This memory system may incorporate a buffer, a temporary storage area optimizing data transfer speeds between different stages of processes, particularly useful for handling the mentioned types of data during computation or communication. The memory 114 may comprise Random Access Memory (RAM), a type of volatile memory, configured to provide fast access to actively used data and employed for tasks such as rendering graphics, running simulations, or processing large datasets related to dimension, design, and architecture data. The memory 114 may comprise storage devices like Solid State Drives (SSDs) or Hard Disk Drives (HDDs) serve for long-term data storage, retaining dimension data and design information even when the power is turned off. The memory system may adopt a hierarchical structure, combining fast but volatile memory with slower but persistent storage, to balance speed and capacity efficiently. The memory 114 may comprise cache memory, a high-speed but small volatile memory, further enhances performance by storing frequently accessed data, aiding in the swift retrieval of essential information related to dimension, design, and architecture data during computational tasks.

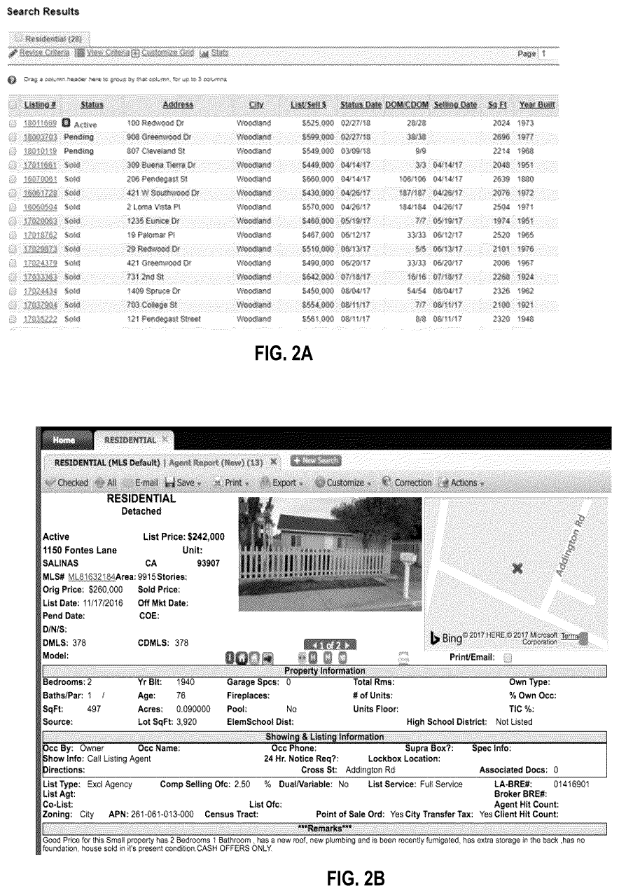

The database 120 may comprise one or more Multiple Listing Services (MLSs). The one or more MLSs may store data as described herein with reference to FIGS. 2A-2B. The database may comprise listing data. The listing data may comprise, for example, details about real estate properties. This information comprises specifics like property address, type, and size, including the number of bedrooms and bathrooms. Additional features, both inside and outside the property, are detailed, along with architectural style and parking information. Financial aspects, such as listing price, property taxes, and homeowner association fees, are also provided. Details about the listing agent and brokerage, property history, and photographs or virtual tours are commonly included. The property description highlights key features, and neighborhood information, school district, and nearby amenities are outlined. Information on property condition, recent renovations, and accessibility details, such as open house schedules and showing instructions, may also be present. Disclosures, energy efficiency features, legal descriptions, and ownership and title information are part of the comprehensive data available in an MLS database, facilitating transparent real estate transactions.

The database may comprise a communications element 122. The computing device may comprise a communications element 122. The communications element 122 may be configured to provide an interface to the computing device 110 and/or the user device 130. The communications element 122 may comprise any interface for presenting and/or receiving information to/from the user device and/or the database. An interface may be a communication interface such as a display screen, a touchscreen, an application interface, a web browser (e.g., Internet Explorer®, Mozilla Firefox®, Google Chrome®, Safari®, or the like). Other software, hardware, and/or interfaces may be used to provide communication between the database 120, the computing device 110 and/or the user device 130. The communications element 122 may request or query various files from a local source and/or a remote source. The communications element 122 may send data to a local or remote device such as the computing device 110.

The database 120 may comprise an address element 123. The address element 123 may be or provide an internet protocol address, a network address, a media access control (MAC) address, an Internet address, or the like. The address element 123 may be relied upon to establish a communication session between the database and the computing device 110 and/or the user device 130. The address element 123 may be used as an identifier or locator of the database 120. The address element 123 may be persistent for a particular network.

The database 120 may comprise an identifier. The identifier may be or relate to an Internet Protocol (IP) Address IPV4/IPV6 or a media access control address (MAC address) or the like. The identifier may be a unique identifier for facilitating communications on the physical network segment. An identifier may be associated with a physical location of the database.

The user device 130 may comprise an application 131. Key functionalities of the application 131 may include data manipulation, communication facilitation, automation of tasks, connectivity to the internet or other devices, and customization of settings. Moreover, the application 131 may leverage platform-specific features to optimize performance and user experience. For example, the application 131 may be configured for sending queries and receiving data associated with a Multiple Listing Service (MLS). The data may comprise dimension data, design data, and architecture data. The dimension data may comprise one or more of: lot size, building size, room dimensions, property boundaries, floor plans, frontage, depth, height, setback, orientation, easements, landscaping features, garage or parking dimensions, additional structures, utility lines, and cubic footage.

The user device may comprise an interface 132. An interface may be a communication interface such as a display screen, a touchscreen, an application interface, a web browser (e.g., Internet Explorer®, Mozilla Firefox®, Google Chrome®, Safari®, or the like).

The user device may comprise memory 133. The memory 133 may comprise a diverse set of memory components configured for storing and managing different types of data, including dimension data, design data, and architecture data. This memory system may incorporate a buffer, a temporary storage area optimizing data transfer speeds between different stages of processes, particularly useful for handling the mentioned types of data during computation or communication. The memory 133 may comprise Random Access Memory (RAM), a type of volatile memory, configured to provide fast access to actively used data and employed for tasks such as rendering graphics, running simulations, or processing large datasets related to dimension, design, and architecture data. The memory 133 may comprise storage devices like Solid State Drives (SSDs) or Hard Disk Drives (HDDs) serve for long-term data storage, retaining dimension data and design information even when the power is turned off. The memory system may adopt a hierarchical structure, combining fast but volatile memory with slower but persistent storage, to balance speed and capacity efficiently. The memory 133 may comprise cache memory, a high-speed but small volatile memory, further enhances performance by storing frequently accessed data, aiding in the swift retrieval of essential information related to dimension, design, and architecture data during computational tasks.

The user device may comprise a communications element 134. The communications element 134 may be configured to provide an interface to the database 120 and/or the computing device 110. The communications element 134 may comprise any interface for presenting and/or receiving information to/from the user device and/or the database. An interface may be a communication interface such as a display screen, a touchscreen, an application interface, a web browser (e.g., Internet Explorer®, Mozilla Firefox®, Google Chrome®, Safari®, or the like). Other software, hardware, and/or interfaces may be used to provide communication between the user device, 130, the computing device 110 and the database 120. The communications element 134 may request or query various files from a local source and/or a remote source. The communications element 134 may send data to a local or remote device such as the computing device 110 and/or the database 120.

The user device 130 may comprise a device identifier. The device identifier may comprise information relating to an image capture device such as a manufacturer, a model or type of device, a service provider associated with the user device. Other information may be represented by the device identifier. The device identifier may be an address element and/or a service element. The address element may be or provide an internet protocol address, a network address, a media access control (MAC) address, an Internet address, or the like. The address element may be relied upon to establish a communication session between the user device and the computing device 110. The address element may be used as an identifier or locator of the user device 130. The address element 110 may be persistent for a particular network.

For example, extracted data may include (among other items): Cabinetry details—style (slab, raised panel, etc.), color/finish (paint color, stain, etc.), bathroom vanity type (single, double, etc.); finish materials—flooring types and finishes in major areas (kitchen, primary bath, shower, etc.), paint colors in major areas, countertop types; floor plan details—presence on open concept spaces, kitchen islands and peninsulas, flex space details, formal and informal spaces, etc.; exterior features—primary architectural style, landscaping details, front exterior materials, garage and outdoor living spaces (patio, porches, etc.). As an example, using the systems and methods described herein, image analysis of a kitchen from a sold property would show that the kitchen featured dark stained raised-panel cabinetry, white oak hardwood floors, black plumbing features, a peninsula with seating, a paneled refrigerator and stainless steel professional range, and white quartz countertops. This information is derived though programmatic annotation of the property image—and then paired with the knowledge that the property sold after 42 days on the market, in zip code 30092, with a sales price of $530,000 (information derived from text data on the property listing itself).

The ML/AI system utilizes computer vision algorithms to analyze images of multifamily units, identifying characteristics such as building facades, unit layouts, common areas, amenities, and exterior features like parking spaces or recreational facilities. Through image analysis, the system can programmatically label properties with tags such as “swimming pool,” “fitness center,” “gated community,” or “modern architecture,” providing valuable insights into the property's appeal and amenities offered.

Similarly, the system employs NLP techniques to parse textual descriptions associated with multifamily listings, extracting information about unit sizes, floor plans, amenities, lease terms, and neighborhood features. Textual descriptions may also contain details about nearby schools, public transportation options, and community services, which contribute to the overall desirability of the multifamily units.

As the ML/AI system continues to analyze multifamily unit data, it learns from patterns and correlations within the dataset. This learning process enables the system to automatically supplement the data with additional labels or attributes based on emerging trends or recurring features observed across properties. For example, if the system detects a high demand for properties with “pet-friendly policies” or “in-unit laundry facilities,” it may programmatically label similar properties with these attributes, even if they are not explicitly mentioned in the original listings.

By programmatically labeling image and text data associated with multifamily units, the ML/AI system may enhance the comprehensiveness and granularity of the dataset, enabling more accurate market analysis, property valuation, supply and investment decision-making for suppliers, real estate professionals, property managers, and investors operating in the multifamily housing market.

In the context of hotels and hospitality within the MLS database system, the ML/AI system for analyzing image and text data plays a pivotal role in comprehensively understanding and categorizing the various features and offerings of these properties. Hotels and hospitality establishments encompass a diverse range of accommodations, from boutique hotels to luxury resorts, each with unique amenities, services, and guest experiences that influence their market appeal and competitiveness.

The ML/AI system may utilize advanced computer vision algorithms to analyze images of hotel properties, identifying key features such as architectural styles, room types, common areas, amenities, and exterior landscapes. Through image analysis, the system can programmatically label hotels with tags such as “oceanfront view,” “poolside lounge,” “spa facilities,” or “conference center,” providing valuable insights into the property's ambiance and offerings.

Similarly, the system may employ natural language processing (NLP) techniques to parse textual descriptions associated with hotel listings, extracting information about room types, amenities, dining options, recreational activities, and nearby attractions. Textual descriptions may also contain details about guest services, such as concierge assistance, room service, and complimentary amenities, which contribute to the overall guest experience and satisfaction.

As the ML/AI system continues to analyze hotel data, it may learn from patterns and correlations within the dataset. This learning process enables the system to automatically supplement the data with additional labels or attributes based on emerging trends or recurring features observed across properties. For example, if the system detects a high demand for “pet-friendly accommodations” or “eco-friendly initiatives,” it may programmatically label similar properties with these attributes, even if they are not explicitly mentioned in the original listings.

By programmatically labeling image and text data associated with hotels and hospitality establishments, the ML/AI system may enhance the depth and granularity of the dataset, enabling more precise market analysis, property valuation, and strategic decision-making for hotel owners, operators, and investors. This comprehensive understanding of hotel properties facilitates targeted marketing efforts, guest experience enhancements, and operational optimizations to meet evolving consumer preferences and industry trends.

For example, the methods and systems described herein may be configured to for selecting the floor plan and constructing a premises with features and design amenities that are linked to higher per square foot values by market (formal dining versus home office; painted kitchen cabinetry versus stained; granite countertop versus quartz; stone versus brick exterior material) and fewer days on market; similarly, which among these options are linked with lower per square foot values and higher days on market. This helps the architecture teams on staff better understand which features are driving sales in each market, which are less important, and where the trends are moving down to the zip code level.

For example, the methods and systems described herein may be configured to give architecture and design teams an idea of which materials should be offered for clients in the design center; ensures that each market (for instance, Atlanta versus Phoenix versus Dallas) offers the finish materials and decorative options that are popular amongst that specific buyer base.

For example, the methods and systems described herein may be configured to guide the design process for spec homes, ensuring that the floor plan and material options used in spec homes are based on timely, local sales data.

For example, the methods and systems herein may be configured for investors assessing and remodeling single family homes at scale, ensures that remodeling decisions are no longer homogenizes (e.g, the influx of grey LVT flooring nationwide) and creates more appealing, location-specific interiors for potential homeowners and renters.

For example, the methods and systems described herein may be configured to achieve more accurate valuations for existing inventory by accessing our proprietary data for sold homes anywhere nationwide. For example, the methods and systems described herein may be configured to facilitate decision making for Trend and Merchandising teams, giving them access to the data necessary to know which materials are trending in home design and which may be on the way out. For example, the methods and systems described herein may be configured to aid merchandising teams in understanding which products and materials are driving sales in each market (and zip code).

For example, the methods and systems described herein may be configured to enable realtors to better advise sellers on how to best prepare a home for market, based on budget (for instance, minor kitchen and bathroom updates, how to stage flex spaces, paint colors that are most appealing, landscaping tweaks, and keyword and marketing terminology). For example, the methods and systems described herein may be configured to embed realtor's own branding on our data graphics to present recommendations and market data to current and prospective clients.

For example, the methods and systems described herein may be configured to make data-backed design and material recommendations to investor and builder clients to design properties that sell quickly and maximize value. For example, the present methods and system may be configured for remodeling clients/homeowners seeking resale value, utilize branded, localized data to ensure that design decisions align with the current and trending preferences of homebuyers within the desired price point.

For example, the present methods and systems may be configured to put local market data in the hands of homeowners themselves, giving them confidence when making decisions pertaining to remodeling and even minor property updates. For example, the methods and systems described herein may be configured to make the cost versus payoff comparison simple and easy to read for the average homeowner (or prospective homeowner).

The present disclosure provides a method for creating a single source residential real estate data model that focuses on interior and exterior architectural design elements to provide a more detailed understanding of the valuation and marketability of a home in a given market. The methods and systems combine existing data with previously untracked data to create a new data class. It provides a single source for residential builders, residential real estate investors and professionals, homeowners, and design professionals to succinctly view the correlation between various design, décor, floor plan, and architectural features as it pertains to sales price and days on market in small and large markets and areas alike.

The present methods and systems may be configured to facilitate decision-making and construction for professionals by consolidating and correlating previously un-tracked data. The present methods and systems may contributes to the evolution of the interior design programming process for builders, investors, and real estate professionals at a time when automating decisions and making strategic purchases is critical to success and profitability.

The present methods and systems may replace a time-consuming manual process, and somewhat haphazard process with an automated one, utilizing AI to train software to quickly aggregate data that would otherwise require impossibly costly man hours and would not allow for timely, relevant data analysis.

Furthermore, the present systems and methods ensure data integrity by using a process that would otherwise be marred by human error (having to use thousands of low-skill laborers to manually labor images). We are now able to produce data with verifiable and accurate results. Errors in programmatic labeling can be continuously monitored by human subject matter experts, and the software itself and the tech can be updated as terminology changes or evolves.

FIGS. 2A-2B shows example data that may be found in one or more real estate databases. For example, as shown in FIG. 2A, the one or more real estate databases comprise one or more Multiple Listing Service (MLS) databases. For example, the information in the one or more real estate databases comprise one or more listing numbers, one or more status indicators (e.g., active, pending, sold), one or more addresses, one or more cities, one or more list/sell prices, one or more status dates, one or more days on market/cumulative days on market (DOM/CDOM) indicators, one or more selling data indictors, one or more square foot indicators, one or more year built indicators, combinations thereof, and the like.

Similarly, as shown in FIG. 2B, the one or more real estate databases may include listing data included one or more list prices, one or more addresses, one or more statuses, pricing information such as an original price, a list price, sold price, etc., map data including an image of a map, property information such as bedrooms, bathrooms, square feet, age, year built, acres, lot square feet, garage spaces, fireplaces, pools, elementary schools, rooms, number of units, high schools, etc . . . . For example, the one or more real estate databases may include showing and listing information.

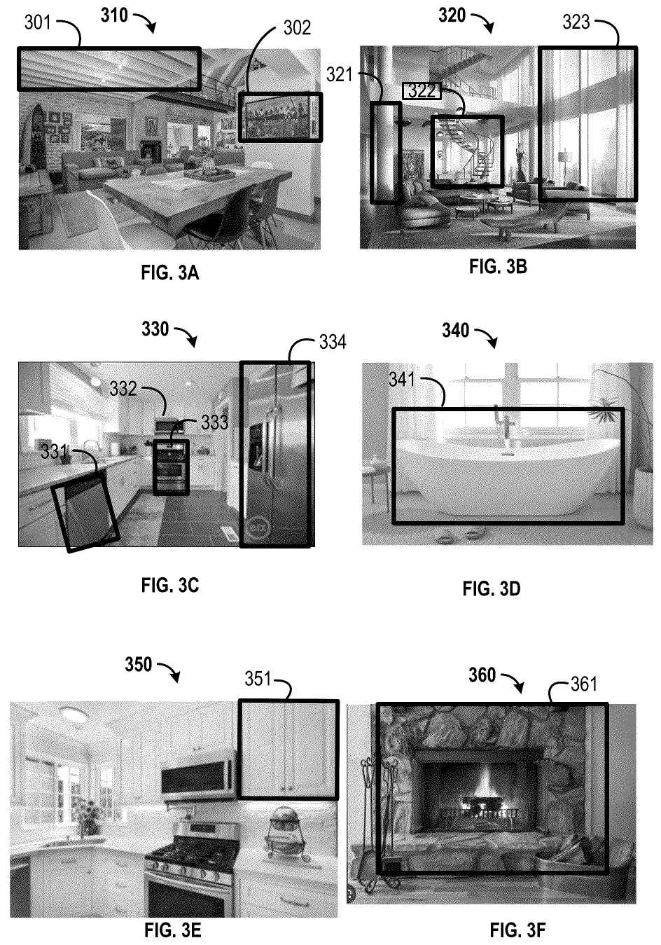

FIGS. 3A-3F show example image data. The image data may comprise one or more photos. For example, the one or more photos may be associated with one or more real estate listings. The systems described herein may be configured to determine one or more dimension features, one or more design features, one or more architectural features, combinations thereof, and the like. For example, the computing device 101 may receive image data and determine dimension data, design data, architecture data, combinations thereof, and the like. For example, as seen in FIG. 3A, the computing device receive image 310 and determine one or more dimension features, design features, and or architecture features. For example, may determine, via object recognition techniques, that image 310 comprises exposed beams 301 and artwork 302. The computing device may determine one or more square foot price trends associated with the exposed beams and the artwork 302. For example, the computing device may determine the exposed beams, by virtue of being integral to the structure of the premises may be associated with a first weight in determining a price per square foot value while the artwork, being a non-permanent design choice, may be associated with a second weight in determining a price per square foot of the premises featured in the image 310.

For example, as seen in FIG. 3B, the computing device may receive image data 320 and determine one or more dimension features, design features, and or architecture features. For example, the computing device 101 may determine image 320 comprises interior pillars 321, a spiral staircase 322, and two-story floor to ceiling window 333. The computing device may determine, based on the data received from the MLS, one or more changes in a square foot price associated with the property featured in image data 320. For example, the computing device that listings featuring spiral staircases tend to have higher square foot prices than listings featuring quarter turn staircases, or straight staircases. Similarly, the computing device may determine that listings featuring two-story floor-to-ceiling windows are associated with higher square foot prices than listings featuring single story floor-to-ceiling windows or standard windows.

For example, as in seen in FIG. 3C, the computing device may receive image data 330 and determine one or more features in the image data 330. For example, image data 330 comprises an image of a kitchen. The computing device 101 may determine, for example, based on object recognition techniques, that the premises associated with the image data 330 comprises a dishwashing machine 331, an oven 332, a microwave 333, and a refrigerator 334. The computing device may, based on the one or more features, adjust (e.g., determine) one or more square foot values, and or changes therein. For example, the computing device may determine the one or more appliances have matching stainless steel finishes. The computing device may determine that, for similar houses in the area, stainless steel is associated with higher square foot prices than black or white finishes but lower square foot prices than paneled finishes.

For example, as seen in FIG. 3D, the computing device may receive the image data 340. The computing device 101 may determine the image data comprises a freestanding bathtub 341, 342. The computing device 101 may determine one or more market trends (e.g., square foot prices) associated with the presence of a freestanding bathtub. For example, the computing device may determine that the price per square foot tends to increase with the presence of a freestanding bathtub.

Similarly, as seen in FIG. 3E, the computing device may receive the image data 350. The computing device 101 may determine the image data 350 comprises an image of an arched door 351. The computing device 101 may determine one or more buyer preferences, market trends, or the like associated with listings featuring white recessed panel kitchen cabinet doors. For example, the computing device 101 may determine listings featuring white recessed panel kitchen cabinet doors generally have a higher square foot price than similar listings that do not feature white recessed panel kitchen cabinet doors.

Similarly, as seen in FIG. 3F, the computing device may receive the image data 360. The computing device 101 may be configured to determine one or more property features such as a stone fireplace 361.

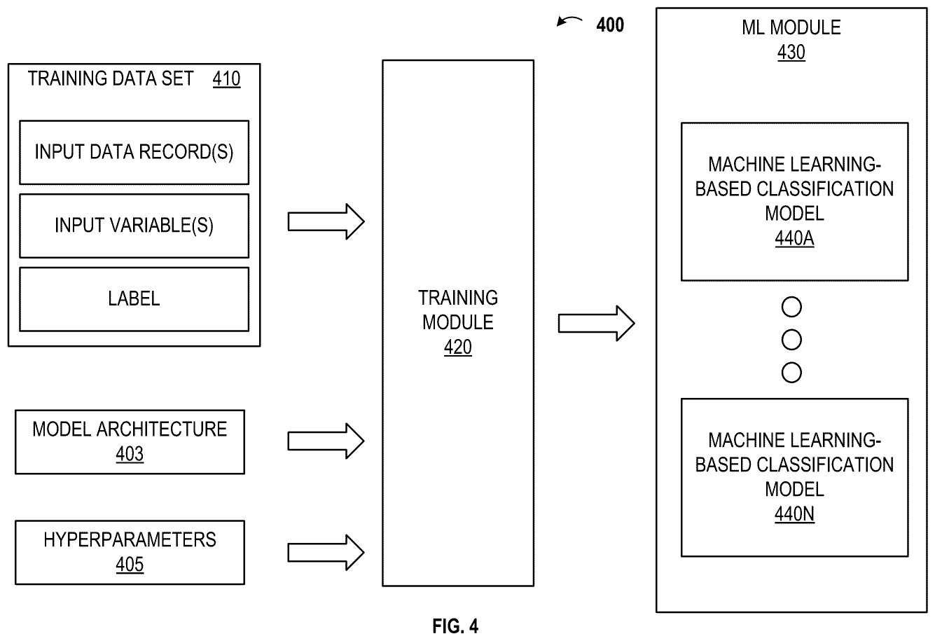

Turning now to FIG. 4, an example method 400 is shown. While FIG. 4 illustrates a training method, it is to be understood that the systems and methods described herein may be implemented via pre-trained model. The method 400 may be performed based on an analysis of one or more training data sets 410 by a training module 420, at least one ML module 430 that is configured to provide one or more of a prediction or a score associated with data records and one or more corresponding variables. The training module 420 may be configured to train and configure the ML module 430 using one or more hyperparameters 405 and a model architecture 403. The model architecture 403 may comprise a predictive model as described herein. The hyperparameters 405 may comprise a number of neural network layers/blocks, a number of neural network filters (e.g., convolutional filters) in a neural network layer, a number of epochs etc. For text features, a transformer-based encoder model may be used. For image features, one or more CNN based models may be used. Each set of the hyperparameters 405 may be used to build the model architecture 503, and an element of each set of the hyperparameters 405 may comprise a number of inputs (e.g., data record attributes/variables) to include in the model architecture 403. For example, the first set of hyperparameters 405 may be associated with a first model. The first model may be associated with a first task (e.g., a source task). The first task may comprise population level analysis. The second set of hyperparameters 405 may be associated with a second model. The second model may be associated with a second task (e.g., the target task). In other words, an element of each set of the hyperparameters 405 may indicate that as few as one or as many as all corresponding attributes of the data records and variables are to be used to build the model architecture 403 that is used to train the ML module 430.

The training data set 410 may comprise one or more input data records associated with one or more labels (e.g., a binary label (yes/no, hypo/non-hypo), a multi-class label (e.g., hypo/non/hyper) and/or a percentage value). The label for a given record and/or a given variable may be indicative of a likelihood that the label applies to the given record. A subset of the data records may be randomly assigned to the training data set 410 or to a testing data set. In some implementations, the assignment of data to a training data set or a testing data set may not be completely random. In this case, one or more criteria may be used during the assignment. In general, any suitable method may be used to assign the data to the training or testing data sets, while ensuring that the distributions of yes and no labels are somewhat similar in the training data set and the testing data set.

The training module 420 may train the ML module 430 by extracting a feature set from a plurality of data records (e.g., labeled as yes, hypo/hyper, no for normo) in the training data set 410 according to one or more feature selection techniques. For example, text-based and image-based features may be extracted which describe the subject matter present in an input content. The training module 420 may train the ML module 430 by extracting a feature set from the training data set 410 that includes statistically significant features of positive examples (e.g., labeled as being yes) and statistically significant features of negative examples (e.g., labeled as being no).

The training module 420 may extract a feature set from the training data set 410 in a variety of ways. The training module 420 may perform feature extraction multiple times, each time using a different feature-extraction technique. In an example, the feature sets generated using the different techniques may each be used to generate different machine learning-based classification models 440A-440N. For example, the feature set with the highest quality metrics may be selected for use in training. The training module 420 may use the feature set(s) to build one or more machine learning-based classification models 440A-440N that are configured to indicate whether a particular label applies to a new/unseen data record based on its corresponding one or more variables.

The training data set 410 may be analyzed to determine any dependencies, associations, and/or correlations between features and the yes/no labels in the training data set 410. The identified correlations may have the form of a list of features that are associated with different yes/no labels. The term “feature,” as used herein, may refer to any characteristic of an item of data that may be used to determine whether the item of data falls within one or more specific categories. A feature selection technique may comprise one or more feature selection rules. The one or more feature selection rules may comprise a feature occurrence rule. The feature occurrence rule may comprise determining which features in the training data set 410 occur over a threshold number of times and identifying those features that satisfy the threshold as candidate features.

Two commonly-used retraining approaches are based on initialization and feature extraction. In the initialization approach the whole network is further trained, while in the feature extraction approach the last few fully-connected layers are trained from a random initialization, and other layers remain unchanged. In addition to these two approaches, a third approach may be implemented by combining these two approaches (e.g., the last few fully-connected layers are further trained, and other layers remain unchanged).

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training data set 410 to generate a first list of features. A final list of candidate features may be determined, generated, and/or analyzed according to additional feature selection techniques to determine one or more candidate feature groups (e.g., groups of features that may be used to predict whether a label applies or does not apply). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., yes/no).

As another example, one or more candidate feature groups may be selected according to a wrapper method. A wrapper method may be configured to use a subset of features and train a machine learning model using the subset of features. Based on the inferences that drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature groups. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature groups. Backward elimination is an iterative method that begins with all features in the machine learning model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside (e.g., includes and/or excludes) the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate one or more machine learning-based classification models 440A-440N based on the feature set(s). A machine learning-based classification model may refer to a complex mathematical model for data classification that is generated using machine-learning techniques. In one example, the machine learning-based classification model 440 may include a map of support vectors that represent boundary features. By way of example, boundary features may be selected from, and/or represent the highest-ranked features in, a feature set. The boundary features may be configured to separate or classify data points into different categories or classes.

The training module 420 may use the feature sets extracted from the training data set 410 to build the one or more machine learning-based classification models 440A-440N for each classification category (e.g., yes, no, hypo/non, hypo/non/hyper). In some examples, the machine learning-based classification models 440A-440N may be combined into a single machine learning-based classification model 440. Similarly, the ML module 430 may represent a single classifier containing a single or a plurality of machine learning-based classification models 440 and/or multiple classifiers containing a single or a plurality of machine learning-based classification models 440.

The extracted features (e.g., one or more candidate features) may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting ML module 430 may comprise a decision rule or a mapping for each candidate feature.

The candidate feature(s) and the ML module 430 may be used to predict whether a label applies to a data record in the testing data set. In one example, the result for each data record in the testing data set includes a confidence level that corresponds to a likelihood or a probability that the one or more corresponding variables are indicative of the label applying to the data record in the testing data set. The confidence level may be a value between zero and one, and it may represent a likelihood that the data record in the testing data set belongs to a yes/no status with regard to the one or more corresponding variables. In one example, when there are two statuses (e.g., yes and no), the confidence level may correspond to a value p, which refers to a likelihood that a particular data record in the testing data set belongs to the first status (e.g., yes). In this case, the value 1-p may refer to a likelihood that the particular data record in the testing data set belongs to the second status (e.g., no). In general, multiple confidence levels may be provided for each data record in the testing data set and for each candidate feature when there are more than two labels. A top performing candidate feature may be determined by comparing the result obtained for each test data record with the known yes/no label for each data record. In general, the top performing candidate feature will have results that closely match the known yes/no labels. The top performing candidate feature(s) may be used to predict the yes/no label of a data record with regard to one or more corresponding variables. For example, a new data record may be determined/received. The new data record may be provided to the ML module 430 which may, based on the top performing candidate feature, classify the label as either applying to the new data record or as not applying to the new data record.

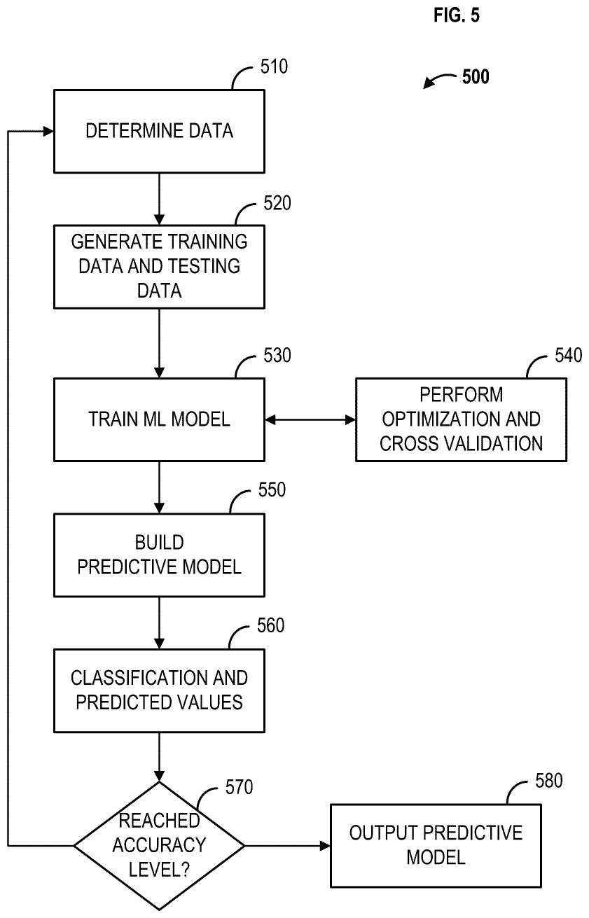

FIG. 5 shows a flowchart illustrating an example training method 500 for generating the ML module 430 using the training module 420 is shown. The training module 420 can implement supervised, unsupervised, and/or semi-supervised (e.g., reinforcement based) machine learning-based classification models 440A-440N. The training module 420 may comprise a data processing module and/or a predictive module. The method 500 illustrated in FIG. 5 is an example of a supervised learning method; variations of this example of training method are discussed below, however, other training methods can be analogously implemented to train unsupervised and/or semi-supervised machine learning models.

The training method 500 may determine (e.g., access, receive, retrieve, etc.) first data records that have been processed by the data processing module at step 510. The first data records may comprise a labeled set of data records. The labels may correspond to a label (e.g., yes or no). The training method 500 may generate, at step 520, a training data set and a testing data set. The training data set and the testing data set may be generated by randomly assigning labeled data records to either the training data set or the testing data set. In some implementations, the assignment of labeled data records as training or testing samples may not be completely random. As an example, a majority of the labeled data records may be used to generate the training data set. For example, 65% of the labeled data records may be used to generate the training data set and 65% may be used to generate the testing data set. The training data set may comprise population data that excludes data associated with a target patient.

The training method 500 may train one or more machine learning models at step 530. In one example, the machine learning models may be trained using supervised learning. In another example, other machine learning techniques may be employed, including unsupervised learning and semi-supervised. The machine learning models trained at 530 may be selected based on different criteria depending on the problem to be solved and/or data available in the training data set. For example, machine learning classifiers can suffer from different degrees of bias. Accordingly, more than one machine learning model can be trained at 530, optimized, improved, and cross-validated at step 540.

For example, a loss function may be used when training the machine learning models at step 530. The loss function may take true labels and predicted outputs as its inputs, and the loss function may produce a single number output. The present methods and systems may implement a mean absolute error, relative mean absolute error, mean squared error and relative mean squared error using the original training dataset without data augmentation.

One or more minimization techniques may be applied to some or all learnable parameters of the machine learning model (e.g., one or more learnable neural network parameters) in order to minimize the loss. For example, the one or more minimization techniques may or may not be applied to one or more learnable parameters, such as encoder modules that have been trained, a neural network block(s), a neural network layer(s), etc. This process may be continuously applied until some stopping condition is met, such as a certain number of repeats of the full training dataset and/or a level of loss for a left-out validation set has ceased to decrease for some number of iterations. In addition to adjusting these learnable parameters, one or more of the hyperparameters 405 that define the model architecture 403 of the machine learning models may be selected. The one or more hyperparameters 405 may comprise a number of neural network layers, a number of neural network filters in a neural network layer, etc. For example, as discussed above, each set of the hyperparameters 405 may be used to build the model architecture 403, and an element of each set of the hyperparameters 405 may comprise a number of inputs (e.g., data record attributes/variables) to include in the model architecture 503. The element of each set of the hyperparameters 405 comprising the number of inputs may be considered the “plurality of features” as described herein. That is, the cross-validation and optimization performed at step 540 may be considered as a feature selection step. An element of a second set of the hyperparameters 405 may comprise data record attributes for a particular patient. In order to select the best hyperparameters 405, at step 540 the machine learning models may be optimized by training the same using some portion of the training data (e.g., based on the element of each set of the hyperparameters 405 comprising the number of inputs for the model architecture 403). The optimization may be stopped based on a left-out validation portion of the training data. A remainder of the training data may be used to cross-validate. This process may be repeated a certain number of times, and the machine learning models may be evaluated for a particular level of performance each time and for each set of hyperparameters 405 that are selected (e.g., based on the number of inputs and the particular inputs chosen).

A best set of the hyperparameters 405 may be selected by choosing one or more of the hyperparameters 405 having a best mean evaluation of the “splits” of the training data. This function may be called for each new data split, and each new set of hyperparameters 405. A cross-validation routine may determine a type of data that is within the input (e.g., attribute type(s)), and a chosen amount of data (e.g., a number of attributes) may be split-off to use as a validation dataset. A type of data splitting may be chosen to partition the data a chosen number of times. For each data partition, a set of the hyperparameters 405 may be used, and a new machine learning model comprising a new model architecture 403 based on the set of the hyperparameters 405 may be initialized and trained. After each training iteration, the machine learning model may be evaluated on the test portion of the data for that particular split. The evaluation may return a single number, which may depend on the machine learning model's output and the true output label. The evaluation for each split and hyperparameter set may be stored in a table, which may be used to select the optimal set of the hyperparameters 405. The optimal set of the hyperparameters 405 may comprise one or more of the hyperparameters 405 having a highest average evaluation score across all splits.

The training method 500 may select one or more machine learning models to build a predictive model at 550. The predictive model may be evaluated using the testing data set. The predictive model may analyze the testing data set and generate one or more of a prediction or a score at step 560. The one or more predictions and/or scores may be evaluated at step 570 to determine whether they have achieved a desired accuracy level. Performance of the predictive model may be evaluated in a number of ways based on a number of true positives, false positives, true negatives, and/or false negatives classifications of the plurality of data points indicated by the predictive model.

For example, the false positives of the predictive model may refer to a number of times the predictive model incorrectly classified a label as applying to a given data record when in reality the label did not apply. Conversely, the false negatives of the predictive model may refer to a number of times the machine learning model indicated a label as not applying when, in fact, the label did apply. True negatives and true positives may refer to a number of times the predictive model correctly classified one or more labels as applying or not applying. Related to these measurements are the concepts of recall and precision. Generally, recall refers to a ratio of true positives to a sum of true positives and false negatives, which quantifies a sensitivity of the predictive model. Similarly, precision refers to a ratio of true positives a sum of true and false positives. When such a desired accuracy level is reached, the training phase ends and the predictive model (e.g., the ML module 430) may be output at step 580; when the desired accuracy level is not reached, however, then a subsequent iteration of the training method 500 may be performed starting at step 510 with variations such as, for example, considering a larger collection of data records.

The present methods and systems may incorporate programmatic labeling. Programmatic labeling is a method of automatically generating labels for training data using predefined rules, heuristics, weak supervision, or machine learning models, rather than relying entirely on manual human annotation. This approach significantly reduces the time and cost associated with human labeling while allowing datasets to be labeled at scale. Instead of manually tagging each data point, programmatic labeling leverages various techniques, such as rule-based labeling, distant supervision, weak supervision, and self-supervision. Rule-based labeling uses domain knowledge to define heuristic rules—for instance, automatically labeling a listing as “luxury” if it mentions “marble countertops” or “high-end finishes.” Distant supervision, on the other hand, incorporates external data sources to provide weak labels, such as using a real estate database to categorize home styles. Machine learning models can also be trained to predict labels for unlabeled data, refining their accuracy over time through iterative learning.

In real estate applications, programmatic labeling can be particularly useful for identifying home features from listings, analyzing pricing trends, and detecting neighborhood preferences. For example, a system could automatically tag homes with “modern” characteristics if the listing descriptions include terms like “open floor plan” or “stainless steel appliances.” Similarly, computer vision models could scan listing photos to detect and label features like arched doorways or bay windows. When analyzing pricing trends, programmatic labeling can categorize properties as “overpriced” or “underpriced” based on historical sales data and market conditions. Additionally, clustering techniques can group similar listings by their architectural features, while external sources such as Yelp reviews mentioning home attributes can be used to infer regional style preferences.

The advantages of programmatic labeling include scalability, cost efficiency, consistency, and adaptability. By automating the labeling process, it enables large datasets to be processed quickly and ensures uniformity in how data is tagged, reducing human subjectivity. It is also cost-effective, as it minimizes the need for manual annotators while allowing models to learn dynamically from evolving market trends. Implementing programmatic labeling can be facilitated by various tools and frameworks, such as Snorkel and Labelbox, which help automate and refine the labeling process.

Various approaches can be used to automatically generate labels for text, images, and structured data while reducing reliance on manual annotation. For example, the present methods and systems may implement weak supervision, where labeling functions-rules, heuristics, or predictive models—are applied to generate labels from raw data. For instance, a system can automatically tag homes as “luxury” if listing descriptions mention features like “marble countertops” or “vaulted ceilings.” For example, the present methods and systems may implement semi-automated labeling, where an AI model pre-labels data, and human reviewers refine uncertain cases.

For example, for large-scale datasets, the present methods and systems may implement active learning to enhance labeling efficiency. In this method, the model automatically labels most data points but flags ambiguous cases for human validation, ensuring accuracy while minimizing manual effort. For example, the present methods and systems may incorporate transfer learning, where pre-trained models recognize patterns in unstructured data, such as automatically tagging listing descriptions with relevant property attributes like “waterfront,” “gated community,” or “smart home features.” For example, the present methods and systems may incorporate interactive AI-assisted labeling, where a model continuously learns from human feedback, improving its predictions over time.

Beyond these approaches, several key strategies can further refine programmatic labeling. For example, the present methods and systems may incorporate rule-based labeling which applies predefined conditions to assign labels, such as categorizing a property as “modern” if the description includes terms like “stainless steel appliances” or “open floor plan.” The present methods and systems may incorporate distant supervision making use of external data sources, such as historical sales trends, to provide weak labels for price classification. The present methods and systems may incorporate self-supervised learning which enables models to learn patterns from unstructured data, allowing them to group similar home images or descriptions without predefined labels. The present methods and systems may incorporate, clustering techniques to identify trends in real estate preferences by grouping properties with similar features based on text descriptions or images.

The programmatic labeling system described here may be configured to generate actionable recommendations (and/or automatically take action based on those recommendations) for suppliers and builders on which materials to stock based on market demand. By leveraging machine learning models trained on MLS data-including listing descriptions, images, pricing, and buyer preferences—the system can identify emerging trends in home construction and design within specific geographic areas. For example, if the system detects a rising preference for marble countertops over quartz in high-end homes within a certain region, it can recommend that local suppliers increase their inventory of marble slabs. Similarly, if homebuyers in a particular market show a growing preference for arched doorways over standard square designs, builders can adjust their material orders and design plans accordingly.

For example, the system may use predictive analytics and clustering techniques to group homes based on shared design features and construction materials. The system may analyze past sales data, consumer preferences, and regional style trends to forecast which materials are likely to be in higher demand in the coming months. The system may be configured to output a recommendation and/or take an action with respect to the recommendation such as making a purchase, ordering materials, or in the case of automated construction, cause a premises to be built. The system may employ natural language processing (NLP) applied to listing in order to extract mentions of specific materials, finishes, and architectural details. For example, while computer vision models may analyze property images to identify patterns in flooring, cabinetry, and exterior finishes. Additionally, by incorporating external data sources such as building permits and supplier inventory levels, the system can provide a comprehensive analysis of supply-demand dynamics.

The recommendation engine may be configured to provide data-driven insights tailored to different stakeholders. The system may generate and output reports to suppliers on the most in-demand materials, enabling them to optimize stock levels and reduce surplus inventory. Builders can use these insights to align their construction plans with market trends, ensuring their projects incorporate materials and designs that appeal to buyers. Additionally, real estate agents and developers can leverage this information to highlight popular home features when marketing properties.

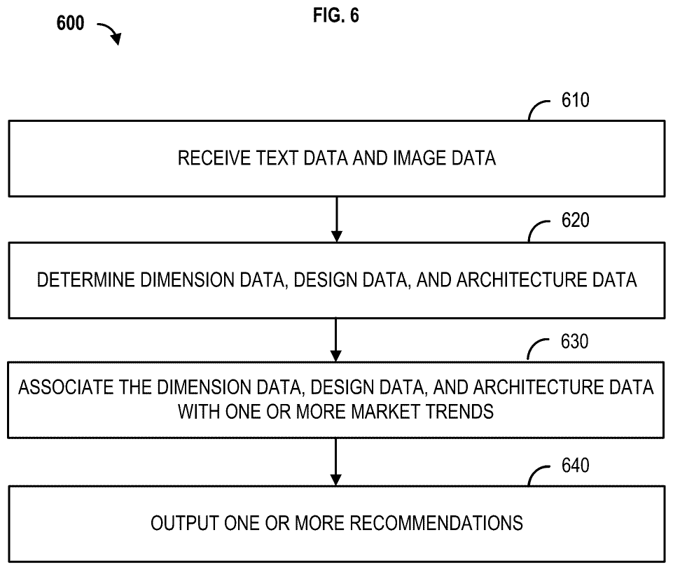

FIG. 6 shows an example method 600. The method may be carried out via any one or more of the devices described herein. At 610, text data and image data may be received. For example, the computing device may be configured to receive the text data and/or image data via one or more communication protocols and/or application program interfaces (APIs) such as the RESO (Real Estate Standards Organization) Web API, the RETS (Real Estate Transaction Standards), both of which are hereby incorporated by reference, or other similar standards, protocols or interfaces

The image data and text data may be received by a computing device. The image data and text data may be received from one or more real estate databases (e.g., one or more multiple listing service (MLS) databases). The image data may comprise one or more photographs, videos, combinations thereof, or the like. The text data may comprise data contained in any one or more fields of the real estate database. The real estate database may be configured to store information associated with various fields. For example, various data fields capture essential details about properties, including address, legal description, property type (e.g., residential, commercial, land), size, and dimensions. Listings include pricing information, listing dates, and status indicators such as whether a property is active, pending, or sold. Detailed features like the number of bedrooms and bathrooms, square footage, lot size, and year built are recorded, along with information on amenities, special features (e.g., pool, fireplace), and included appliances. Property condition details, such as the age and condition of major systems, provide insights for potential buyers.

For example, one or more architectural features may comprise a diverse array of elements, including a roof design featuring architectural shingles, dormers, or skylights; a foundation features such as concrete or stone; walls materials like brick, stucco, or siding; flooring options such as hardwood, tile, or carpet; windows with architectural details like bay windows or custom frames; doors, both interior and exterior, designed with unique aesthetics in mind; one or more entryway features such as a high or low foyer; open or closed floor plans; ceilings features like vaulted designs or exposed beams; kitchens features such as old or modern appliances, stylish cabinetry, countertops and associated materials; bathroom features such as soaking tubs or walk-in showers; windows that maximize or minimize natural light and ventilation; exterior elements ranging from landscaping to porches, balconies, and diverse exterior cladding materials; architectural lighting placement; built-in storage features; fireplaces; staircases (e.g., standard, landings, spiral, etc . . . ); architectural trim and molding adding decorative accents to walls, doors, and windows; smart home technology integration; the presence of absence of energy-efficient features including sustainable materials and systems.

For example, location-related data may include neighborhood details, school district information, and proximity to amenities like parks or public transportation. Financial aspects, including property taxes and homeowner association (HOA) fees, are often included. Sales history, detailing previous sales, sale prices, and dates, contributes to the overall property context. Agent and broker information, including the details of the listing agent and brokerage, is part of the MLS data. Visual representation is facilitated by photographs and images, including both interior and exterior views and virtual tours. Additionally, accessibility instructions and showing details provide practical information for property viewings. It's noteworthy that the specifics of MLS data may vary based on regional standards, property types, and individual MLS organization practices. This rich array of information empowers real estate professionals and potential buyers in making well-informed decisions about properties.

The computing device may be configured for optical character recognition. For example, a specialized computing device configured with optical character recognition (OCR) technology may be configured to receive and/or scan one or more real estate listings and extract relevant information. For example, the system may be configured to capture textual data from images, such as property listings, brochures, or flyers. The OCR software may convert the captured text into machine-readable data, allowing the computing device to automatically extract details such as property addresses, square footage, room dimensions, listing prices, and other information. By leveraging OCR algorithms, the device can accurately interpret diverse font styles, sizes, and layouts commonly found in real estate documents. The computing device can be integrated into real estate workflows for aggregating property information from various listings in a standardized and easily accessible format.

The computing device may be configured for object detection and recognition. For example, an artificial intelligence system may determine various design features by leveraging advanced image analysis techniques applied to visual data obtained from an MLS database. Through machine learning algorithms, the system can be trained to recognize and interpret key elements such as room layouts, flooring types, wall finishes, and overall interior aesthetics. Computer vision models can identify patterns, textures, and color schemes, extracting valuable information about the design elements present in property images. Additionally, the system may utilize object detection algorithms to identify specific features like lighting fixtures, furniture arrangements, or built-in structures (e.g., a fireplace). By processing and understanding these visual cues, the artificial intelligence system can autonomously extract rich interior design insights, providing a comprehensive and accurate representation of the property's aesthetic and functional attributes. This enables users to access valuable information about a property's interior design directly from the visual data available in a databases of sold properties.

At 620, dimension data associated with the one or more premises, design data associated with one or more premises, architecture data associated with one or more premises, and premises listing data associated with the one or more premises may be determined. The premises listing data may include, for example, changes in price, days on market, initial price, price relative to prices of other premises in the area, price change relative to price changes of other premises in the area, combinations thereof, and the like. The dimension data associated with the one or more premises, premises design data associated with one or more premises, architectural data associated with one or more premises, and premises listing data associated with the one or more premises may be determined based on one or more of the image data and/or the text data received from the real estate database. The dimension data may comprise one or more of: lot size, building size, room dimensions, approximate room sizes (e.g., size of kitchen or primary bath relative to total square footage), property boundaries, floor plans, frontage, depth, height, setback, orientation, easements, landscaping features, garage or parking dimensions, additional structures, utility lines, and cubic footage. For example, the design data may include information about interior design such as details about the arrangement and dimensions of rooms within the property, information regarding the materials used for flooring in different areas, descriptions of wall materials, finishes, and colors throughout the interior, details about the design, height, and materials of the ceilings, specifications for light fixtures, including types and locations, information about curtains, blinds, or other window coverings, descriptions of built-in furniture, shelves, or storage units, details about the design, materials, and placement of fireplaces, information about kitchen and laundry appliances, details regarding the design, materials, and finishes of cabinets in kitchens and bathrooms, information about the materials and dimensions of kitchen and bathroom countertops, specifications for interior doors, including style and materials, descriptions of the color schemes used throughout the property, information about the arrangement of furniture in various rooms, details about any unique or special interior design features, information regarding home automation systems and smart home features, descriptions of artwork and decorative elements within the property, information about the types and materials of textiles used, such as curtains, rugs, and upholstery, details about the design and materials of sinks, faucets, and other bathroom fixtures, and information regarding the presence and type of storage solutions, including closets and built-in storage.

For example, architectural data may include architectural style date (e.g., information about the design style of the building, such as Colonial, Victorian, Modern, or Mediterranean), materials used (e.g., details on the construction materials employed, such as brick, wood, concrete, or steel), roof type (e.g., description of the style and material of the roof, whether it's gabled, flat, pitched, or uses architectural shingles), facade details (e.g., ornamental features on the exterior, including decorative trim, columns, shutters, or architectural embellishments), windows and doors design (e.g., information about the style, size, and material of windows and doors, including any unique architectural features), architectural elements (e.g., features like arches, dormers, balconies, or porticos that contribute to the building's overall design), interior layout (e.g., configuration and design of interior spaces, including the arrangement of rooms, hallways, and common areas), historical significance (e.g., any historical or cultural significance associated with the architectural design or the building itself), specialized features (e.g., skylights, fireplaces, built-in shelving, or unique staircases), landscaping design (e.g., architectural aspects related to the outdoor space, including gardens, patios, pathways, and other landscaping features), combinations thereof, and the like.

At 630, one or more of the premises dimensions data, premises design data, premises architectural data, or premises listing data may be associated with one or more valuation trends. For example, the one or more valuation trends may comprise one or more square foot prices. The computing device may be configured to determine which features contribute to an increase in square foot prices. For example, to determine which features contribute to increases in square foot prices, a computing device with access to comprehensive Multiple Listing Service (MLS) data, may collect a dataset from the MLS. The dataset may comprise one or more property listings featuring relevant details such as square footage, architectural nuances, amenities, and other potential influencers of property prices. Following data collection, the computing device may clean and preprocess the information, addressing missing or inconsistent data and standardizing formats for uniform analysis.

The computing device may be configured to perform feature selection. For example, the computing device may employ correlation analysis to identify potential factors associated with changes in square foot price, days on market trends, or other trends. Regression models, such as multiple linear regression, may be utilized to quantify relationships between various features and square foot prices, providing insights into significant contributors. Advanced machine learning models, including decision trees, random forests, or gradient boosting, may be employed determine patterns and nonlinear associations within the data. Variable importance assessments within the chosen model may be used to rank features based on their impact on square foot prices. To ensure model generalizability, cross-validation techniques may be implemented, splitting the dataset into training and testing sets for validation as described herein. Interpretability tools may be applied, especially for complex models, to elucidate how specific features contribute to price increases. The computing device may continuously monitor the real estate market, updating its models with new data to ensure ongoing relevance and accuracy, providing valuable insights for both buyers and sellers navigating the dynamic real estate landscape.

At 640, one or more recommendations may be output. For example, the computing device may compile one or more recommendations and format them for output via one or more user interfaces (e.g., one or more displays). The one or more recommendation may include, for example, a) which floor plan features are best for each neighborhood and market b) which materials are best for spec homes in each neighborhood c) what materials should be added, kept, and eliminated from their design center based on trends d) how should their floor plans evolve based on trends) what exterior elements/features matter to target buyer, combinations thereof, and the like.

The method may comprise constructing one or more premises according to the one or more recommendations. For example, one or more pieces of construction equipment may be caused to automatically construct one or more premises according to the one or more building recommendations. For example, a central computing device may sent, to the one or more pieces of instruction equipment, instructions configured to cause the one or more pieces of construction equipment to construct a premises according to the recommendations. The one or more pieces of instruction equipment may receive the instructions. The one or more pieces of instruction equipment may execute the one or more instructions and construct the premises. The method may further comprise receiving one or more of: updated premises dimensions data associated with the one or more premises, updated premises design data associated with the one or more premises, updated premises architectural data associated with the one or more premises, or updated premises listing data associated with the one or more premises. The method may comprise updating, based on the updated premises dimensions data associated with the one or more premises, updated premises design data associated with the one or more premises, updated premises architectural data associated with the one or more premises, or updated premises listing data associated with the one or more premises, the one or more valuation trends.

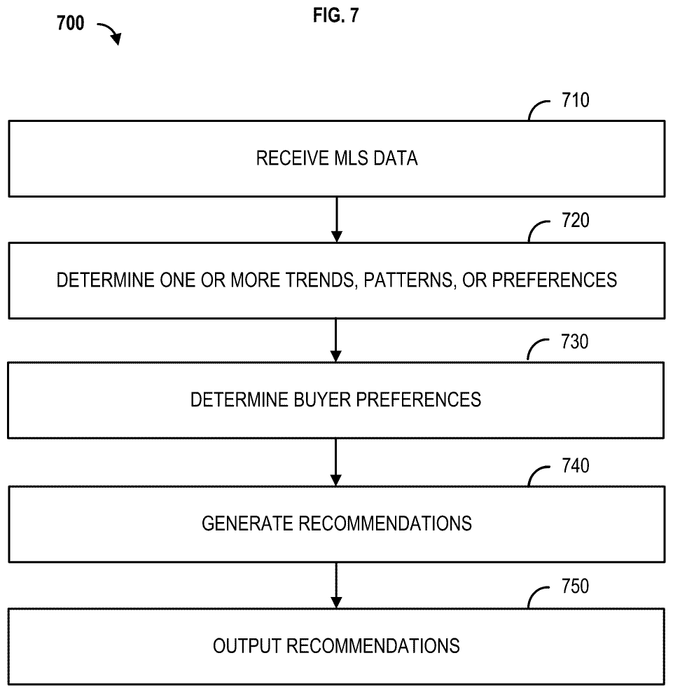

FIG. 7 shows an example method 700. The method 700 may be executed on any one or more devices described herein. At 710, data comprising property features, historical sales information, and market trends may be received. The data comprising property features, historical sales information, and market trends may be received from a data (e.g., a real estate database such as a multiple listing service database). The data comprising property features, historical sales information, and market trends may be received in response to one or more queries sent by a computing device. The received data may comprise one or more of dimension data, design data, architecture data, combinations thereof, or like as described herein.

At 720, the received property features, historical sales information, and market trends may be analyzed by a machine learning model. For example, the machine learning model may be configured to determine one or more patterns, trends, or preferences associated with the property features, historical sales information, or market trends.

At 730, one or more buyer preferences may be determined. For example, the one or more buyer preferences may be determined based on regional market conditions, and other relevant factors using the machine learning model.

At 740, one or more recommendations may be determined. The one or more recommendations may be determined so as to maximize square foot prices. For example, artificial intelligence may be employed to predict and maximize square foot values. The one or more recommendations may be configured to indicate to home supply or home improvement professionals and companies which materials to stock in which stores.

At 750, the one or more recommendations may be output. For example, the computing device may compile the one or more recommendations and format them for output via one or more user interfaces (e.g., one or more displays).

The method may comprise constructing one or more premises according to the one or more recommendations. For example, one or more pieces of construction equipment may be caused to automatically construct one or more premises according to the one or more building recommendations. For example, a central computing device may sent, to the one or more pieces of instruction equipment, instructions configured to cause the one or more pieces of construction equipment to construct a premises according to the recommendations. The one or more pieces of instruction equipment may receive the instructions. The one or more pieces of instruction equipment may execute the one or more instructions and construct the premises. The method may further comprise receiving one or more of: updated premises dimensions data associated with the one or more premises, updated premises design data associated with the one or more premises, updated premises architectural data associated with the one or more premises, or updated premises listing data associated with the one or more premises. The method may comprise updating, based on the updated premises dimensions data associated with the one or more premises, updated premises design data associated with the one or more premises, updated premises architectural data associated with the one or more premises, or updated premises listing data associated with the one or more premises, the one or more valuation trends.

The method may comprise continuously updating recommendations based on real-time changes in MLS data, market conditions, and construction-related factors using the machine learning model. The method may comprise allowing home builders to customize preferences and constraints to tailor recommendations to their specific construction capabilities, target markets, and business objectives using the machine learning model.

The method may comprise receiving, by a computing device, from a real estate database, image data associated with one or more premises and text data associated with the one or more premises. The method may comprise determining, based on the image data associated with the one or more premises and the text data associated with the one or more premises, premises dimensions data associated with the one or more premises, premises design data associated with one or more premises, premises architectural data associated with one or more premises, and premises listing data associated with the one or more premise. The method may comprise associating via a machine learning model, one or more of the premises dimensions data, premises design data, premises architectural data, or premises listing data, with one or more valuation trends.

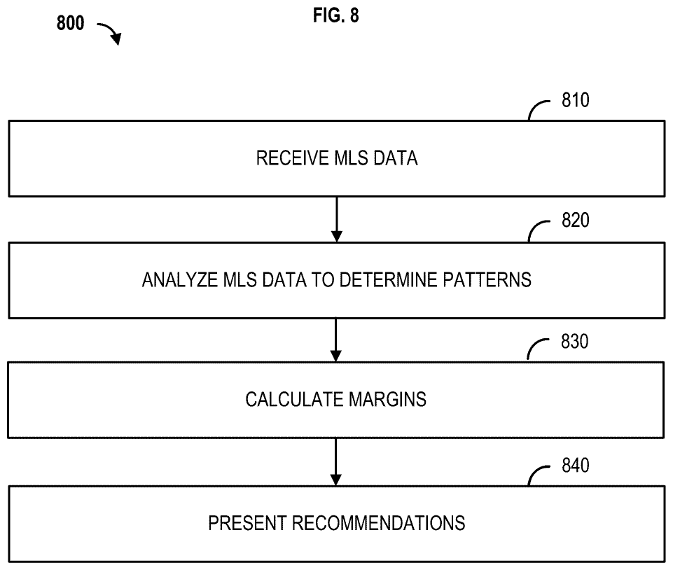

FIG. 8 shows an example method 800. The method 800 may be executed on any one or more devices described herein. At 810, data from one or more multiple listing services (MLSs) may be received. The data may comprise dimension data, design data, architecture data, information related to real estate properties, including but not limited to property features, historical sales data, and market trends, combinations thereof, and the like. The computing device may receive pricing data associated with one or more building materials. The computing device may receive data associated with labor costs.

At 820, one or more patterns, trends, and/or market demands may be determined based on the received data. For example, one or more machine learning and/or artificial intelligence systems may analyze the data.

At 830, construction profit margin data may be determined based on the received data. For example, the method may comprise calculating potential builder margins based on the analyzed data, considering factors such as construction costs, regional market conditions, and historical sales performance; generating recommendations for optimal home configurations and features that are predicted to maximize builder margins, taking into account the analyzed data and calculated margins.

At 840, the one or more recommendations may be output. For example, the computing device may compile the one or more recommendations and format them for output via one or more user interfaces (e.g., one or more displays). The one or more recommendations may be configured to indicate to home supply or home improvement professionals and companies which materials to stock in which stores.

The method may further comprise continuously updating the recommendations based on real-time changes in MLS data (e.g., sold MLS data, sold residential property data, combinations thereof, and the like), market conditions, and construction costs to provide builders with up-to-date and relevant information. The method may comprise allowing home builders, design firms, architecture firms, home sellers, or others to customize preferences and constraints to tailor the recommendations to their specific business goals, construction capabilities, and target markets.

The method may further comprise receiving, by a computing device, from a real estate database, image data associated with one or more premises and text data associated with the one or more premises. The method may comprise determining, based on the image data associated with the one or more premises and the text data associated with the one or more premises, premises dimensions data associated with the one or more premises, premises design data associated with one or more premises, premises architectural data associated with one or more premises, and premises listing data associated with the one or more premise. The method may comprise associating via a machine learning model, one or more of the premises dimensions data, premises design data, premises architectural data, or premises listing data, with one or more valuation trends.

The method may comprise receiving, from one or more Multiple Listing Services (MLS) databases, data comprising property features, historical sales information, and market trends. The method may comprise analyzing the received data using a machine learning model to determine one or more patterns, trends, or preferences associated with various property features and configurations. The method may comprise determining buyer preferences based on historical data, regional market conditions, and other relevant factors using the machine learning model. The method may comprise generating one or more recommendations for optimal home configurations and features, employing the machine learning model to predict and enhance square foot values.

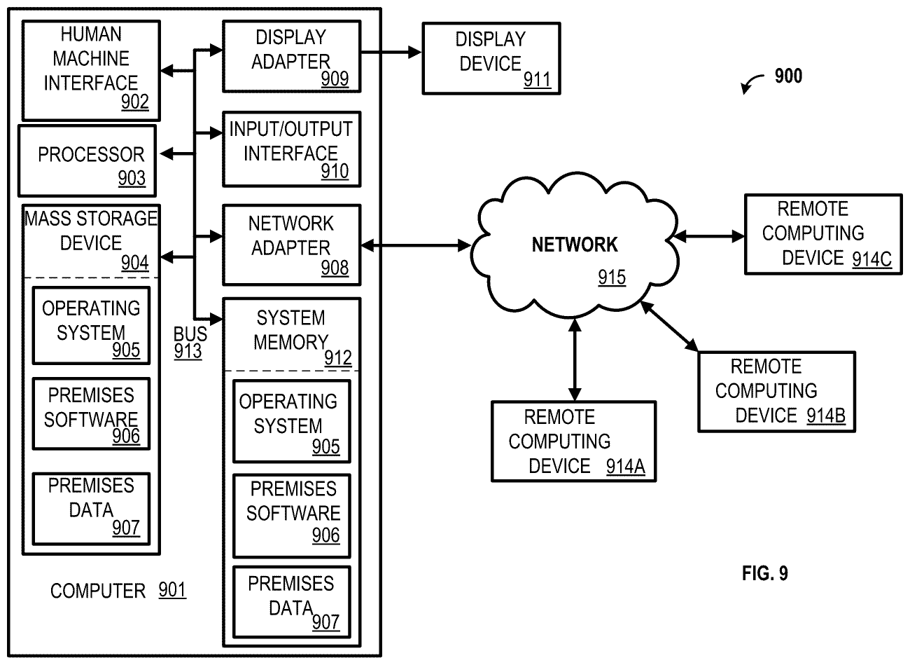

The methods and systems may be implemented on a computer 901 as shown in FIG. 9 and described below. The computing device 110, the database 120, and/or the user device 130 of FIG. 1 may be a computer 901 as shown in FIG. 9. Similarly, the methods and systems described may utilize one or more computers to perform one or more functions in one or more locations. FIG. 9 is a block diagram of an operating environment for performing the present methods. This operating environment is a single configuration of many possible configurations of an operating environment, and it is not intended to suggest any limitation as to the scope of use or functionality of operating environment architecture. Neither should the operating environment be interpreted as having any dependency or requirement relating to any one or combination of components shown in the operating environment.

The present methods and systems may be operational with numerous other general purpose or special purpose computing system environments or configurations. Well-known computing systems, environments, and/or configurations that may be suitable for use with the systems and methods may be, but are not limited to, personal computers, server computers, laptop devices, and multiprocessor systems. Additional computing systems, environments, and/or configurations are set top boxes, programmable consumer electronics, network PCs, minicomputers, mainframe computers, distributed computing environments that are composed of any of the above systems or devices, and the like.

The processing of the present methods and systems may be performed by software components. The described systems and methods may be described in the general context of computer-executable instructions, such as program modules, being executed by one or more computers or other devices. Generally, program modules are composed of computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 901. The components of the computer 901 may be, but are not limited to, one or more processors 903, a system memory 912, and a system bus 913 that couples various system components including the one or more processors 903 to the system memory 912. The system may utilize parallel computing.

The system bus 913 represents one or more of several possible types of bus structures, including a memory bus or memory controller, a peripheral bus, an accelerated graphics port, or local bus using any of a variety of bus architectures. Such architectures may be an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description may also be implemented over a wired or wireless network connection and each of the subsystems, including the one or more processors 903, a mass storage device 904, an operating system 905, premises software 906, premises data 907, a network adapter 908, the system memory 912, an Input/Output Interface 910, a display adapter 909, a display device 911, and a human machine interface 902, may be contained within one or more remote computing devices 914A,B,C at physically separate locations, connected through buses of this form, in effect implementing a fully distributed system.

The computer 901 is typically composed of a variety of computer readable media. Readable media may be any available media that is accessible by the computer 901 and may be both volatile and non-volatile media, removable and non-removable media. The system memory 912 may be computer readable media in the form of volatile memory, such as random access memory (RAM), and/or non-volatile memory, such as read only memory (ROM). The system memory 912 is typically composed of data such as the premises data 907 and/or program modules such as the operating system 905 and the premises software 906 that are immediately accessible to and/or are presently operated on by the one or more processors 903.

The computer 901 may also be composed of other removable/non-removable, volatile/non-volatile computer storage media. FIG. 9 shows a mass storage device 904, which may provide non-volatile storage of computer code, computer readable instructions, data structures, program modules, and other data for the computer 901. The mass storage device 904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 904, such as the operating system 905 and the premises software 906. Each of the operating system 905 and the premises software 906 (or some combination thereof) may be elements of the programming of the premises software 906. The premises data 907 may also be stored on the mass storage device 904. The premises data 907 may be stored in any of one or more databases known in the art. Such databases are DB2®, Microsoft® Access, Microsoft® SQL Server, Oracle®, MySQL, PostgreSQL, and the like. The databases may be centralized or distributed across multiple systems.

The user may enter commands and information into the computer 901 via an input device (not shown). Such input devices may be, but are not limited to, a keyboard, pointing device (e.g., a “mouse”), a microphone, a joystick, a scanner, tactile input devices such as gloves, and other body coverings, and the like These and other input devices may be connected to the one or more processors 903 via the human machine interface 902 that is coupled to the system bus 913, but may be connected by other interface and bus structures, such as a parallel port, game port, an IEEE 1394 Port (also known as a Firewire port), a serial port, or a universal serial bus (USB).

The display device 911 may also be connected to the system bus 913 via an interface, such as the display adapter 909. It is contemplated that the computer 901 may have more than one display adapter 909 and the computer 901 may have more than one display device 911. The display device 911 may be a monitor, an LCD (Liquid Crystal Display), or a projector. In addition to the display device 911, other output peripheral devices may be components such as speakers (not shown) and a printer (not shown) which may be connected to the computer 901 via the Input/Output Interface 910. Any step and/or result of the methods may be output in any form to an output device. Such output may be any form of visual representation, including, but not limited to, textual, graphical, animation, audio, tactile, and the like. The display device 911 and computer 901 may be part of one device, or separate devices.

The computer 901 may operate in a networked environment using logical connections to one or more remote computing devices 914A,B,C. A remote computing device may be a personal computer, portable computer, smartphone, a server, a router, a network computer, a peer device or other common network node, and so on. Logical connections between the computer 901 and a remote computing device 914A,B,C may be made via a network 915, such as a local area network (LAN) and/or a general wide area network (WAN). Such network connections may be through the network adapter 908. The network adapter 908 may be implemented in both wired and wireless environments. Such networking environments are conventional and commonplace in dwellings, offices, enterprise-wide computer networks, intranets, and the Internet.

Application programs and other executable program components such as the operating system 905 are shown herein as discrete blocks, although it is recognized that such programs and components reside at various times in different storage components of the computing device 901, and are executed by the one or more processors 903 of the computer. An implementation of the premises software 906 may be stored on or sent across some form of computer readable media. Any of the described methods may be performed by computer readable instructions embodied on computer readable media. Computer readable media may be any available media that may be accessed by a computer. Computer readable media may be “computer storage media” and “communications media.” “Computer storage media” may be composed of volatile and non-volatile, removable and non-removable media implemented in any methods or technology for storage of information such as computer readable instructions, data structures, program modules, or other data. Further, computer storage media may be, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning), programmatic labeling systems, combinations thereof, and the like.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and methods and systems described therein be considered exemplary only, with a true scope and spirit being indicated by the following claims.

What is claimed is:

1. A method comprising:
receiving, by a computing device, from a real estate database, image data associated with one or more premises and text data associated with the one or more premises;
determining, based on the image data associated with the one or more premises and the text data associated with the one or more premises, premises dimensions data associated with the one or more premises, premises design data associated with one or more premises, premises architectural data associated with one or more premises, and premises listing data associated with the one or more premises;
programmatically labeling, based on the premises dimensions data, premises design data, premises architectural data, and premises listing data, the image data and text data;
associating via a machine learning model, one or more of the premises dimensions data, premises design data, premises architectural data, or premises listing data, with one or more valuation trends; and
outputting, based on the one or more valuation trends, one or more building recommendations or one or more purchasing recommendations.

2. The method of claim 1, wherein the real estate database comprises a multiple listing network (MLS) database and wherein the one or more valuation trends comprise square foot values, and wherein the image data comprises one or more images captured by an image capture device.

3. The method of claim 1, further comprising constructing one or more premises according to the one or more building recommendations.

4. The method of claim 1, wherein the premises dimensions data comprises one or more of: floor plan data, square footage data, or lot size data, and wherein the premises design data comprises one or more of: cabinetry data, finish materials data, exterior features data, and wherein premises listing data comprises one or more of: pricing data, geographic data, time on market data, seller data, buyer data or agent data.

5. The method of claim 1, wherein associating the one or more of the premises dimensions data, premises design data, premises architectural data, or premises listing data, with one or more valuation trends comprises determining one or more changes in price from a baseline price associated with a premises.

6. The method of claim 1, wherein outputting the one or more premises recommendations comprises generating one or more visual outputs indicating the one or more premises recommendations.

7. The method of claim 1, further comprising:
receiving one or more of: updated premises dimensions data associated with the one or more premises, updated premises design data associated with the one or more premises, updated premises architectural data associated with the one or more premises, or updated premises listing data associated with the one or more premises; and
updating, based on the updated premises dimensions data associated with the one or more premises, updated premises design data associated with the one or more premises, updated premises architectural data associated with the one or more premises, or updated premises listing data associated with the one or more premises, the one or more valuation trends.

8. An apparatus comprising:
one or more processors; and
a memory storing processor-executable instructions that, when executed by the one or more processors, cause the apparatus to:
receive, from a real estate database, image data associated with one or more premises and text data associated with the one or more premises;
determine, based on the image data associated with the one or more premises and the text data associated with the one or more premises, premises dimensions data associated with the one or more premises, premises design data associated with one or more premises, premises architectural data associated with one or more premises, and premises listing data associated with the one or more premises;
programmatically label, based on the premises dimensions data, premises design data, premises architectural data, and premises listing data, the image data and text data;
associate, via a machine learning model, one or more of the premises dimensions data, premises design data, premises architectural data, or premises listing data, with one or more valuation trends; and
output, based on the one or more valuation trends, one or more building recommendations or one or more purchasing recommendations.

9. The apparatus of claim 8, wherein the real estate database comprises a multiple listing network (MLS) database and wherein the one or more valuation trends comprise square foot values, and wherein the image data comprises one or more images captured by an image capture device.

10. The apparatus of claim 8, wherein the processor-executable instructions, when executed by the one or more processors, further cause the one or more processors to construct one or more premises according to the one or more building recommendations.

11. The apparatus of claim 8, wherein the premises dimensions data comprises one or more of: floor plan data, square footage data, or lot size data, and wherein the premises design data comprises one or more of: cabinetry data, finish materials data, exterior features data, and wherein premises listing data comprises one or more of: pricing data, geographic data, time on market data, seller data, buyer data or agent data.

12. The apparatus of claim 8, wherein the processor-executable instructions, that, when executed by the one or more processors, cause the one or more processors to associate the one or more of the premises dimensions data, premises design data, premises architectural data, or premises listing data, with one or more valuation trends further cause the one or more processors to determining one or more changes in price from a baseline price associated with a premises.

13. The apparatus of claim 8, wherein the processor-executable instructions, that, when executed by the one or more processors, cause the one or more processors to output the one or more premises recommendations, further cause the one or more processors to generate one or more visual outputs indicating the one or more premises recommendations.

14. The apparatus of claim 8, wherein the processor-executable instructions, when executed by the one or more processors, further cause the one or more processors to:
receive one or more of: updated premises dimensions data associated with the one or more premises, updated premises design data associated with the one or more premises, updated premises architectural data associated with the one or more premises, or updated premises listing data associated with the one or more premises; and
update, based on the updated premises dimensions data associated with the one or more premises, updated premises design data associated with the one or more premises, updated premises architectural data associated with the one or more premises, or updated premises listing data associated with the one or more premises, the one or more valuation trends.

15. One or more non-transitory computer-readable media storing processor-executable instructions thereon, which, when executed by at least one processor cause the at least one processor to:
receive, from a real estate database, image data associated with one or more premises and text data associated with the one or more premises;
determine, based on the image data associated with the one or more premises and the text data associated with the one or more premises, premises dimensions data associated with the one or more premises, premises design data associated with one or more premises, premises architectural data associated with one or more premises, and premises listing data associated with the one or more premises;
programmatically label, based on the premises dimensions data, premises design data, premises architectural data, and premises listing data, the image data and text data;
associate, via a machine learning model, one or more of the premises dimensions data, premises design data, premises architectural data, or premises listing data, with one or more valuation trends; and
output, based on the one or more valuation trends, one or more building recommendations or one or more purchasing recommendations.

16. The one or more non-transitory computer-readable media of claim 15, wherein the real estate database comprises a multiple listing network (MLS) database and wherein the one or more valuation trends comprise square foot values, and wherein the image data comprises one or more images captured by an image capture device.

17. The one or more non-transitory computer-readable media of claim 15, wherein the processor-executable instructions, when executed by the at least one processor, further cause the at least one processor to construct one or more premises according to the one or more building recommendations.

18. The one or more non-transitory computer-readable media of claim 15, wherein the premises dimensions data comprises one or more of: floor plan data, square footage data, or lot size data, and wherein the premises design data comprises one or more of: cabinetry data, finish materials data, exterior features data, and wherein premises listing data comprises one or more of: pricing data, geographic data, time on market data, seller data, buyer data or agent data.

19. The one or more non-transitory computer-readable media of claim 15,
wherein the processor-executable instructions, that, when executed by the at least one processor, cause the at least one processor to output the one or more premises recommendations, further cause the at least one processor to generate one or more visual outputs indicating the one or more premises recommendations.

20. The one or more non-transitory computer-readable media of claim 15,
wherein the processor-executable instructions, when executed by the at least one processor, further cause the at least one processor to:
receive one or more of: updated premises dimensions data associated with the one or more premises, updated premises design data associated with the one or more premises, updated premises architectural data associated with the one or more premises, or updated premises listing data associated with the one or more premises; and
update, based on the updated premises dimensions data associated with the one or more premises, updated premises design data associated with the one or more premises, updated premises architectural data associated with the one or more premises, or updated premises listing data associated with the one or more premises, the one or more valuation trends.
